(19) United States
(12) Patent Application Publication
(10) Pub. No.: US 2011/0307247 A1
(43) Pub. Date: Dec. 15, 2011

(54) METHOD AND SYSTEM FOR LEXICAL NAVIGATION OF ITEMS

(76) Inventor: Nathan Moroney, Palo Alto, CA (US)

(21) Appl. No.: 12/815,034

(22) Filed: Jun. 14, 2010

(51) Int. Cl. G06F 17/21

(52) U.S. Cl. 704/10; 704/E15.014

(57) ABSTRACT

A method and a system for lexical navigation of a corpus of items are provided. For example, the method may include generating a data structure in a non-transitory, computer readable medium. The data structure may include a number of items, a number of keywords, and a frequency that each of the keywords is associated with each of the items. The method may further include generating a top-level lexical cloud that includes a subset of the keywords. Each keyword in the subset may be associated with a size that is proportional its frequency of occurrence. Finally, the method may include generating a plurality of lower-level lexical clouds by eliminating any one of the plurality of items not associated with a particular one of the keywords from the data structure, and generating the lower level lexical cloud as a second subset of the plurality of keywords that remain in the data structure.

### BACKGROUND

The World-Wide Web (or Web) and other network accessible databases provide large numbers of sources for finding information about products and other items. However, the efficacy of searching may often be limited by a lack of familiarity with the terms used in a particular field.

For example, there are hundreds of print substrates, such as papers, labels, and the like, available from dozens of vendors. The print substrates vary in color, brightness, thickness, gloss, texture, opacity, fluorescence, and other specialty treatments, such as pearlesence, metallics, or translucence. One source for identifying substrates, the paperspecs.com Web site, lists about 4,500 commercial print substrates, each of which may be described using different and often overlapping terminology.

Similarly, in print production, there are exists a large array of unrelated measurement devices and standards, each of which may use its own terminologies to describe products. From the print creation standpoint, there are alphabetic swatchbooks, vendor specific branded terminology, and a steep learning curve for selection of print substrates. The tools to identify print substrates lack a global, intuitive, scalable system or tool for selecting, comparing, and assessing media. Similar problems exist for the identification of items in other information sources, such as technical reports or patents.

### BRIEF DESCRIPTION OF THE DRAWINGS

Certain exemplary embodiments are described in the following detailed description and in reference to the drawings, in which:

FIG. 1 is a block diagram of a lexical navigation system, in accordance with an exemplary embodiment of the present invention;

FIG. 2 is a process flow diagram illustrating a method for analyzing a corpus to generate a data structure for a lexical navigation tool, in accordance to an exemplary embodiment of the present invention;

FIG. 3 is a process flow diagram of a method for using a data structure to navigate a corpus of items, in accordance with an exemplary embodiment of the present invention;

FIG. 4 is a block diagram of a computing system that may be, in accordance with exemplary embodiments of the present invention;

FIG. 5 is a map of code blocks on a non-transitory, computer-readable medium, according to an exemplary embodiment of the present invention;

FIG. 6 is a screen shot of a top-level lexical cloud, in accordance with an exemplary embodiment of the present invention;

FIG. 7 is a screen shot of a lower-level lexical cloud obtained by the selection of canvas in FIG. 6, in accordance with an exemplary embodiment of the present invention; and

FIG. 8 is a screen shot of an item list obtained from searching the data structure of the corpus for items that are associated with both canvas and glossy, in accordance with an exemplary embodiment of the present invention.

### DETAILED DESCRIPTION OF SPECIFIC EMBODIMENTS

The extensive use of networks and networked databases has made large amounts of information on products, reports, and other items easily accessible. However, successfully locating specific items, such as specific data sets, answers to specific questions, or products that meet specific needs may often depend on knowing the terminology used in relevant sources of information. Further, different terms may be used to describe the same concepts. For example, there are many vendor-specific or channel-specific media swatchbooks. The swatchbooks tend to be ordered alphabetically or by general category. There are also numerous independent standard metrics for quantifying media properties. However there is no natural language paper selection tool that is cross-vendor, cross-technology, and robust. Thus, to select a media for a commercial print job, a designer must refer to multiple swatchbooks or consult with a print service provider to specify a paper and hope that the print service provider has an appropriate substrate. There is no way for a designer to get a sense of which media are comparable or to efficiently explore a larger range of media.

An exemplary embodiment of the present invention provides a lexical or word-based navigation system and method based on an interactive visualization of a corpus that includes collections of data. This technique uses automatically extracted keywords to create a hierarchy of lexical clouds. The lexical clouds provide a joint visualization of the relative frequency of usage of terms and patterns of collocation of terms based on the keywords. The basic technique is scalable and applicable to many other domains, such as navigation of technical reports or exploring specific topics in intellectual property.

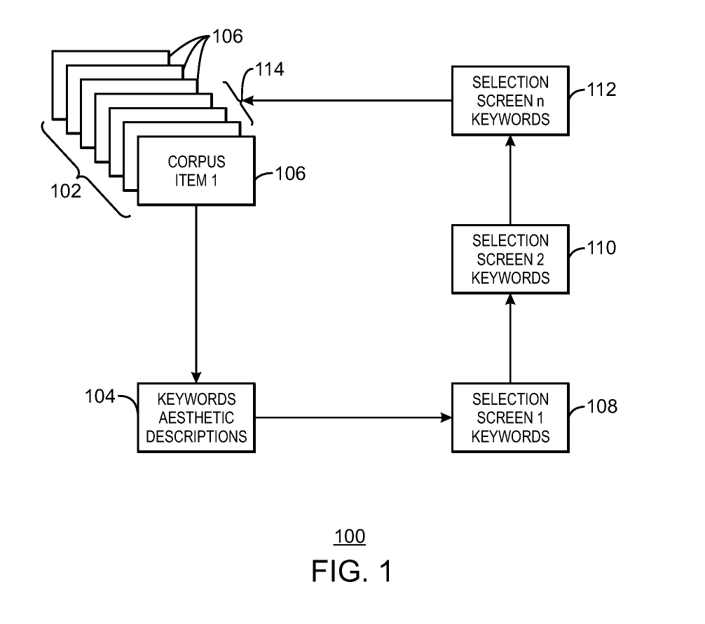

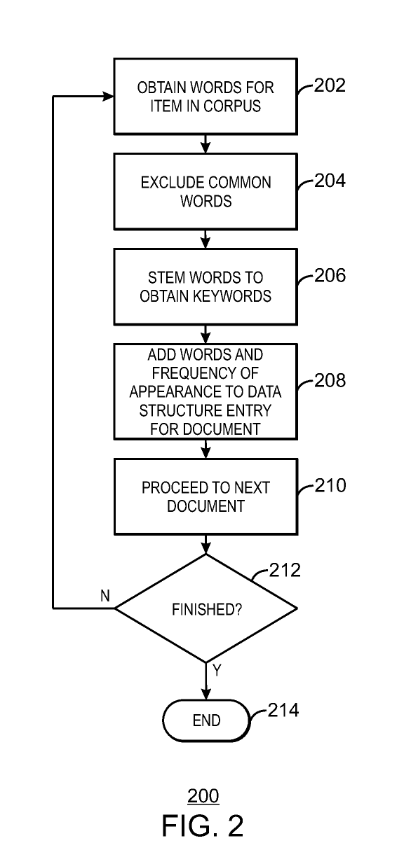

FIG. 1 is a block diagram of a lexical navigation system 100, in accordance with an exemplary embodiment of the present invention. In the lexical navigation system 100, a corpus 102 of items can be used to generate a data structure 104 that associates keywords or aesthetic descriptors with their frequency of occurrence for each item 106 in the corpus 102. The items 106 may be papers for printing jobs, packaging materials for new products, reports, or any number of other items. The keywords for the data structure 104 may be obtained by analyzing a section of a document or by obtaining descriptive words from individuals examining each of the items 106, as discussed further with respect to FIG. 2

A first selection screen 108, showing a top-level lexical cloud, can be generated from the keywords in the data structure 104. The size of a target display may be used to determine the number of keywords that can be effectively displayed. That number of the most frequently occurring keywords in the data structure 104 can be displayed on the first selection screen 108. In other embodiments, the lexical clouds may be precomputed for a fixed number of keywords. The words may be arranged, for example, in alphabetic order and sized by the frequency of occurrence in the corpus 102.

When a user selects one of the keywords, a temporary data structure can be generated from the data structure 104 that eliminates any items 106 in the corpus 102 that are not associated with the keyword selected. From the temporary data structure, a second selection screen 110 can be generated using the same techniques as used to generate the first selection screen 108.

However, as mentioned previously, the selection screens 108 and 110 do not have to be created in real time. Instead, the nested lexical clouds may be pre-computed for each of the most frequently occurring keywords. The precomputed, nested clouds may include the terms frequently used in combination with the specific word in the top-level lexical cloud. Thus, user may access the nested clouds (lower level selection screens) by clicking on a word in the top-level lexical cloud.

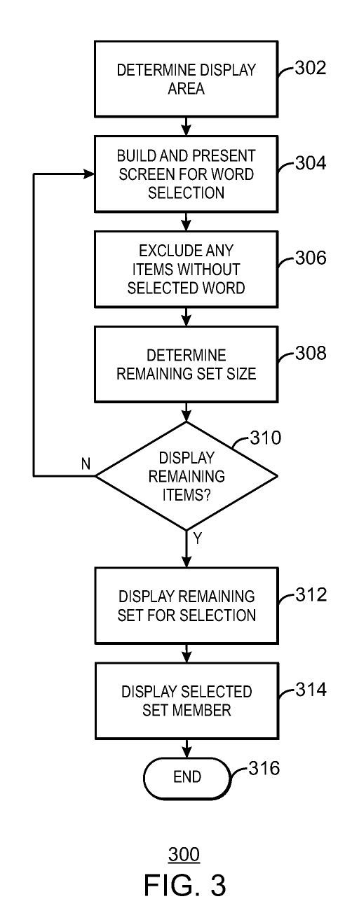

The process may be repeated to generate further selection screens 112. The generation of selection screens 10, 110, and 112 may be stopped and a resulting subset 114 of the corpus 102 displayed when the number of items 106 in the subset 114 can be effectively displayed on a target screen. The procedure for analyzing the items 106 in the corpus 102 to generate the data structure 104 is discussed further with respect to FIG. 2. Further, the procedure for using the information in the data structure 104 to generate selection screens 108, 110, and 112 and for interacting with a user is discussed further with respect to FIG. 3.

FIG. 2 is a process flow diagram illustrating a method 200 for analyzing a corpus to generate a data structure for a lexical navigation tool, in accordance to an exemplary embodiment of the present invention. The method 200 starts at block 202 by analyzing the items in the corpus to obtain words associated with each item. In embodiments, the keywords may be obtained, for example, by taking words from the same section of each of a number of documents making up the corpus. In other embodiments, the words may be obtained from a list of aesthetic descriptions associated with each item in the corpus, as discussed with respect to the example, below. Using the basic steps of corpus linguistics, the words can be processed by spell checking and converted to lower case.

At block 204 the list of words for each item in the corpus may be processed to eliminate common or unimportant words, such as “a,” “the,” “HTTP,” Tag,” and the like. A list of commonly used or unimportant words, termed a stop list, may be generated by analyzing publicly accessible documents of a similar type to the target items in the corpus.

At block 206, a stemming algorithm, such as a Porter stemming algorithm, may be applied to eliminate common suffixes and further narrow the list. The words were stemmed for words ending in -s, -y, -d, -ly, and -cy that otherwise matched, such as mapping “glossy” to “gloss.” After the stemming algorithm was applied, a normalized list of keywords remains.

At block 208, the keywords and a frequency of their appearance in, or association with, each target item may be added to the data structure. If the item is a complex document, such as a patent or technical report, frequency algorithms may be applied to select only a subset of the words if desired. Such algorithms may eliminate words that are used too few times in an item to be significant, for example, words that appear only once, twice, or a few times. The number of occurrences may be controlled depending on the complexity of the corpus. For example, if the corpus is based on descriptive keywords entered by a person based on an aesthetic description of an item, one or two occurrences of a word may be sufficient.

At block 210, a counter or other indicator may be incremented for processing to proceed to the next document or item in the corpus. At block 212, a determination of whether there is another item in the corpus is made. If so, process flow returns to block 202 to analyze the next item in the corpus. If not, process flow proceeds to block 214, where the data structure is output for use in generating the lexical clouds.

A data structure generated by the procedure in FIG. 2 may resemble Table 1, below. In Table 1, the corpus items are along the top and the keywords are listed along the left. The frequency of each keyword associated with each item is listed as the value for each entry and the sums of the keywords are shown in the column labeled “SUM.” In this example, the keywords are arranged by their overall frequency of occurrence in the data structure, in other words, by the sum of the occurrences in all of the items of the corpus.

TABLE 1
Example of a Data structure for Lexical Cloud

| | | Item | Item | Item | Item | Item | Item | Item | |
|---|---|---|---|---|---|---|---|---|---|
| | | 1 | 2 | 3 | 4 | 5 | 6 | 7 | SUM |
| 1 | Word 6 | | 8 | | 6 | | 8 | 7 | 29 |
| 2 | Word 16 | | | 8 | 4 | 7 | 5 | | 24 |
| 3 | Word 14 | | 6 | 9 | 7 | | | | 22 |
| 4 | Word 7 | 8 | 5 | 5 | | 3 | | | 21 |
| 5 | Word 12 | | | 7 | 5 | | 8 | | 20 |
| 6 | Word 5 | 4 | | | 3 | | 8 | 4 | 19 |
| 7 | Word 3 | 4 | 6 | | | | 6 | 2 | 18 |
| 8 | Word 2 | 1 | 9 | | | | 5 | 2 | 17 |
| 9 | Word 9 | 1 | | 9 | | | | 6 | 16 |
| 10 | Word 1 | 5 | | | 3 | | 2 | 4 | 14 |
| 11 | Word 15 | 6 | | | | 2 | | 5 | 13 |
| 12 | Word 8 | | 3 | 4 | 3 | | 2 | | 12 |
| 13 | Word 11 | 6 | | | | 5 | | | 11 |
| 14 | Word 10 | 5 | | | | 1 | 1 | 2 | 9 |
| 15 | Word 4 | | | 2 | | 3 | | 2 | 7 |
| 16 | Word 13 | | | | 1 | | | 2 | 3 |

FIG. 3 is a process flow diagram of a method 300 for using a data structure to navigate a corpus of items, in accordance with an exemplary embodiment of the present invention. The method 300 begins at block 302 by determining the size of a target display area. The size of a target display area may be used to determine the number of words that may be effectively displayed within that area. For example, a computer screen may allow for the display of a significant number of words, such as 50, 100, or 150, while a cell phone screen may only display 5, 10, or 15 words effectively. It can be recognized that these numbers are merely exemplary and lesser or greater numbers of words may be displayed, depending on the problem. Further, if the area is changed, such as a window being resized, the number of words displayed may also be changed, expanding or shrinking to fit the space. The method 300 is not limited to determining the size of the display area. In embodiments, lower-level lexical clouds are precomputed for immediate display upon selection of a keyword in a higher-level lexical cloud.

At block 304, a selection screen including a lexical cloud may be constructed and displayed. For example, if the space available allows for the display of five keywords from Table 1, the five keywords with the highest frequency, or usage, may be selected. As shown in rows 1-5 of Table 1, these would be Word 6, Word 16, Word 14, Word 7, and Word 12. The keywords may be arranged in any order, for example, alphabetically. Further, the words may be sized to match their frequency of occurrence, shown in the SUM column of Table 1. A user may then select one of the keywords, such as by clicking on the keyword on the screen. For explanation, it can be assumed that the user has selected Word 6.

At block 306, a temporary data structure may be created where any Item that is not associated with the selected word is eliminated. For example, the selection of Word 6 eliminates Items 1, 3, and 5, resulting in the data structure shown in Table 2. As Word 11 is not in any of the remaining Items, it may also be eliminated from the structure. At block 306, the size of the remaining set may be determined. In the example shown in Table 2, four Items, 2, 4, 6, and 7, are left after the selection of the first keyword, Word 6. The number of remaining items in the corpus may then be compared to the size of the display area to determine if there is enough space to effectively display the items, as indicated at block 310. If the size of the display area is too small to effectively display the remaining items, process flow returns to block 304.

TABLE 2
Example of a Temporary Data structure
for Secondary Lexical Cloud

| | | Item | Item | Item | Item | |
|---|---|---|---|---|---|---|
| | | 2 | 4 | 6 | 7 | SUM |
| 1 | Word 6 | 8 | 6 | 8 | 7 | 29 |
| 2 | Word 2 | 9 | | 5 | 2 | 16 |
| 3 | Word 5 | | 3 | 8 | 4 | 15 |
| 4 | Word 3 | 6 | | 6 | 2 | 14 |
| 5 | Word 14 | 6 | 7 | | | 13 |
| 6 | Word 12 | | 5 | 8 | | 13 |
| 7 | Word 16 | | 4 | 5 | | 9 |
| 8 | Word 1 | | 3 | 2 | 4 | 9 |
| 9 | Word 8 | 3 | 3 | 2 | | 8 |
| 10 | Word 9 | | | | 6 | 6 |
| 11 | Word 7 | 5 | | | | 5 |
| 12 | Word 15 | | | | 5 | 5 |
| 13 | Word 10 | | | 1 | 2 | 3 |
| 14 | Word 13 | | 1 | | 2 | 3 |
| 15 | Word 4 | | | | 2 | 2 |

Upon returning to block 304, the process repeats using the data structure shown in Table 2. Assuming the size of the display area has not changed, five keywords may be displayed. In this case, the five highest frequency keywords are Word 6, Word 2, Word 5, Word 3, and Word 14. The keywords may also be displayed in alphabetical order and sized according to their relative frequency in Table 2.

Selecting another keyword can lead to the generation of another temporary data structure, as discussed with respect to block 306. For example, selecting Word 14 can result in the data structure shown in Table 3.

TABLE 3
Example of a Temporary Data structure
for a Tertiary Lexical Cloud

| | | Item 2 | Item 4 | SUM |
|---|---|---|---|---|
| 1 | Word 6 | 8 | 6 | 14 |
| 2 | Word 14 | 6 | 7 | 13 |
| 3 | Word 2 | 9 | | 9 |
| 4 | Word 3 | 6 | | 6 |
| 5 | Word 8 | 3 | 3 | 6 |
| 6 | Word 12 | | 5 | 5 |
| 7 | Word 7 | 5 | | 5 |
| 8 | Word 16 | | 4 | 4 |
| 9 | Word 5 | | 3 | 3 |
| 10 | Word 1 | | 3 | 3 |
| 11 | Word 13 | | 1 | 1 |

In this example, at block 308, the remaining set size can be determined to be two. At block 310, the size of the remaining set is again compared to the size of the display area to determine if the remaining set can be displayed. If, at block 310, the size of the display is determined to be sufficient to display the remaining items, at block 312, the items are displayed. In the example discussed above, Items 2 and 4 would be displayed for user selection. If a user selects one of these items, at block 314, the item is displayed, for example, a description, ordering information, company contacts, technical reports, and the like. The method 308 ends at block 316.

If the lexical clouds are precomputed before display, the number of levels will be determined prior to a selection of a keyword. For example, a user may select a keyword in a top-level lexical cloud, resulting in the display of a second-level lexical cloud that has been precomputed. The user may then select a keyword in the second-level lexical cloud resulting in the display of the items associated with the two keywords. One of skill in the art would recognize that precomputed lexical clouds are not limited to two levels, but may have any number of levels, depending, for example, on the complexity of the navigation problem.

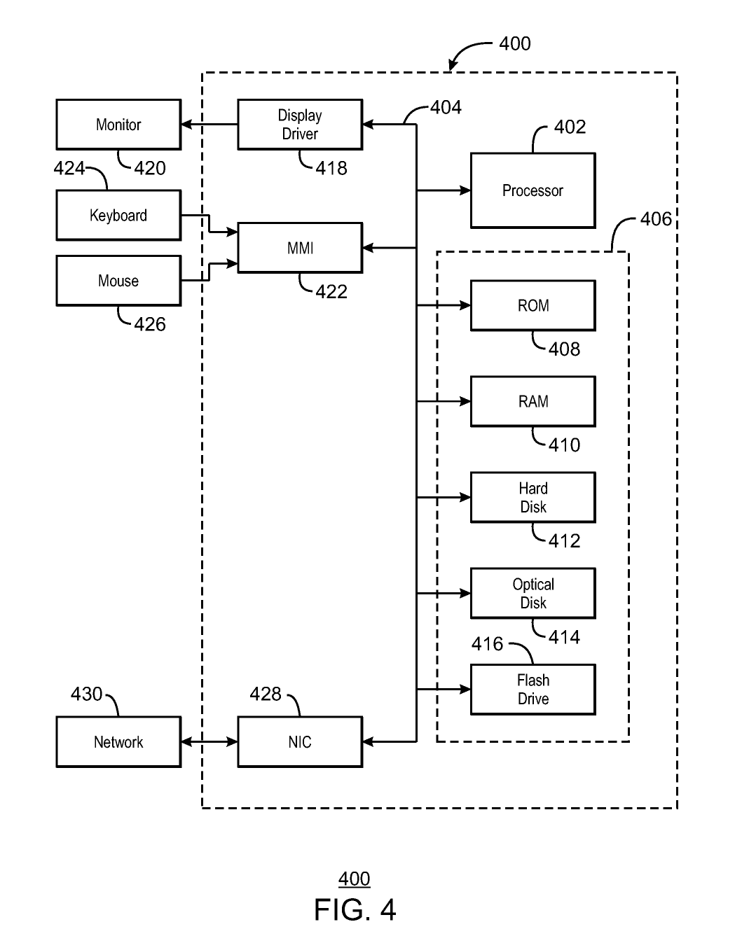

FIG. 4 is a block diagram of a computing system 400 that may be used in exemplary embodiments of the present invention. The computing device 400 can have a processor 402 for booting the computing device 400 and for running programs. The processor 402 can use one or more buses 404 to communicate with other functional units. The buses 404 can include both serial and parallel buses, which can be located fully within the computing device 400 or can extend outside of the computing device 400.

The computing device 400 will generally have non-transitory, computer-readable media 406 for the processor 402 to store programs and data. The non-transitory, computer-readable media 406 can include read only memory (ROM) 408, which can store programs for booting the computing device 400. The ROM 408 can include, for example, programmable ROM (PROM) and electrically programmable ROM (EPROM), among others. The non-transitory, computer-readable media 406 can also include random access memory (RAM) 410 for storing programs and data during operation of the computing device 400. Further, the non-transitory, computer-readable media 406 can include units for longer-term storage of programs and data, such as a hard drive 412 or an optical disk drive 414. One of ordinary skill in the art will recognize that the hard drive 412 does not have to be a single unit, but can include multiple hard drives or a drive array. Similarly, the computing device 400 can include multiple optical drives 414. The optical drives 414 may include compact disk (CD)-ROM drives, Digital Versatile Disc (DVD)-ROM drives, CD/RW drives, DVD/RW drives, Blu-Ray drives, and the like. The non-transitory, computer-readable media 406 can also include flash drives 416, which may communicate with the processor 402 or the computing device 400 through a universal serial bus (USB).

The computing device 400 can be configured to operate as a lexical navigation system according to an exemplary embodiment of the present invention. Moreover, the non-transitory, computer-readable medium 406 can store machine-readable instructions such as computer code that, when executed by the processor 402, cause the computing device 400 to perform a method according to an exemplary embodiment of the present invention, such as the methods 200 and 300 discussed with respect to FIGS. 2 and 3.

The computing device 400 can have any number of other units attached to the buses 404 to provide functionality. For example, the computing device 400 can have a display driver 418, such as a video card installed on a PCI or AGP bus or an integral video system on the motherboard. The display driver 418 can be coupled to one or more monitors 420 to display information from the computing device 400. For example, the computing device 400 can be adapted to transform data collected on a corpus according to an exemplary embodiment of the present invention into a visual representation of a lexical cloud that is displayed on the monitor 420.

The computing device 400 can have a man-machine interface (MMI) 422 to obtain input from various user input devices, for example, a keyboard 424 or a mouse 426. The MMI 422 can also include software drivers to operate an input device connected to an external bus (for example, a mouse connected to a USB) or can include both hardware and software drivers to operate an input device connected to a dedicated port (for example, a keyboard connected to a PS2 keyboard port).

Other units can be coupled to the buses 404 to allow the computing device 400 to communicate with external networks or computers. For example, a network interface controller (NIC) 428 can facilitate communications over an Ethernet connection between the computing device 400 and an external network 430, such as a local area network (LAN) or the Internet. The computing device 400 may access corpus items over the network 430, and generate a data structure for a lexical navigation system.

The computing device 400 can be a server, a laptop computer, a desktop computer, a netbook computer, or any number of other computing devices 400. Different types of computing devices 400 can have different configurations of the devices listed above. For example, a server may not have a dedicated monitor 420, keyboard 424, or mouse 426, instead using a network interface to connect to a managing computer system.

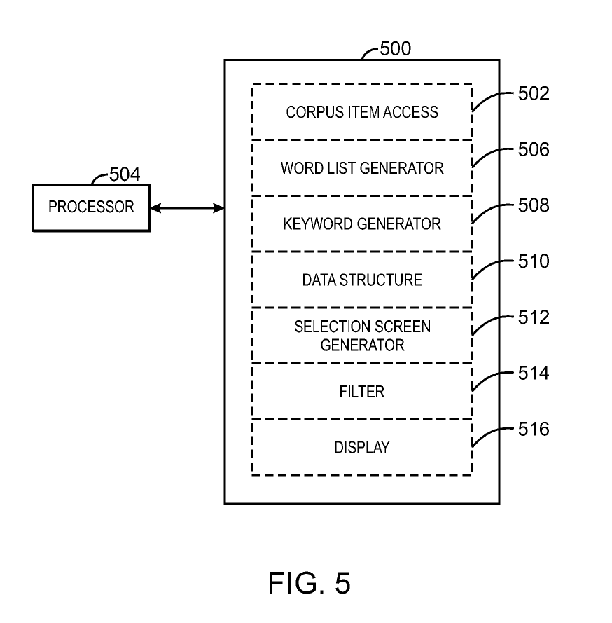

FIG. 5 is a map of code blocks on a non-transitory, computer-readable medium, according to an exemplary embodiment of the present invention. The non-transitory, computer-readable medium shown in FIG. 5 may be any of the units shown in block 406 in FIG. 4, among others. For example, the non-transitory, computer-readable medium may contain a code block 502 configured to direct a processor 504 to access a plurality of information sources to identify corpus items for determining keywords. Another code block may direct a processor 504 to obtain words associated with each of the items in a corpus.

The non-transitory, computer-readable medium may also contain a code block 508 configured to direct a processor to process the words by spell checking the words, converting the words to lower case, excluding common words and stemming words. This processing can generate a data structure containing a list of keywords and frequencies of association with an item in a corpus. Further, as shown in block 510, the non-transitory, computer-readable medium may contain the data structure. The non-transitory, computer-readable medium may also contain a code block 512 configured to direct a processor to generate a selection screen and obtain a user selection. The non-transitory, computer-readable medium may also contain a code block 514 configured to direct a processor to filter items not containing a selected word from the data structure. Further, as shown in block 516, the non-transitory, computer-readable medium may contain a code block configured to analyze a size of a display and display items that fit within the size of the display.

The code blocks are not limited to that shown in FIG. 5. In other exemplary embodiments, the code blocks may include code for obtaining aesthetic descriptions of items in a corpus. Further, the code blocks may be arranged or combined in different configurations from that shown.

### Example

An exemplary embodiment of the present invention was tested to determine the efficacy of the method in identifying particular types of items in a complex data set. The test was carried out by binding media into unique magazines of 20 pages each, where each page was a different substrate. One hundred different media were used from multiple vendors, including 60 commercial print media. The magazines were 9.5 by 6.5 inches and were face stapled with a cloth perfect bound strip for a cover.

A web page was used to collect user visual and tactile evaluations of the substrates, for example, aesthetic descriptions of the substrate such as glossy, stiff, blue, and the like. The evaluations were unconstrained and allowed free description of each of the pages. The use of the magazine form factor allowed for the efficient distribution of substrates, and the use of unconstrained input allowed the direct construction of a domain specific corpus or machine-encoded representative sampling of text or speech for a linguistic application. The web interface allowed multiple, distributed participants to provide their visual and tactile descriptions in parallel and at a convenient time.

Once an experimental corpus that included the nominal scaling of the visual and tactile properties of the media was created, a data structure for a lexical navigation system was created, for example, using the method of FIG. 2. As described with respect to FIG. 2, the descriptive words were cleaned by the application of spell checking and a conversion to lower case. Next, a stop list was derived from words common to 16 different fiction and non-fiction texts obtained from Project Gutenberg. The stop list was applied to remove commonly occurring words like “the” and “of.” The words were stemmed for words ending in -s, -y, -d, -ly, and -cy that otherwise matched, such as changing “glossy” to “gloss.” The process was repeated until all items in the corpus had been processed to create keywords and frequencies of association with each of the items in the corpus. From the data structure a top level lexical cloud was created consisting of the most commonly used words, for example, using the method described with respect to FIG. 3.

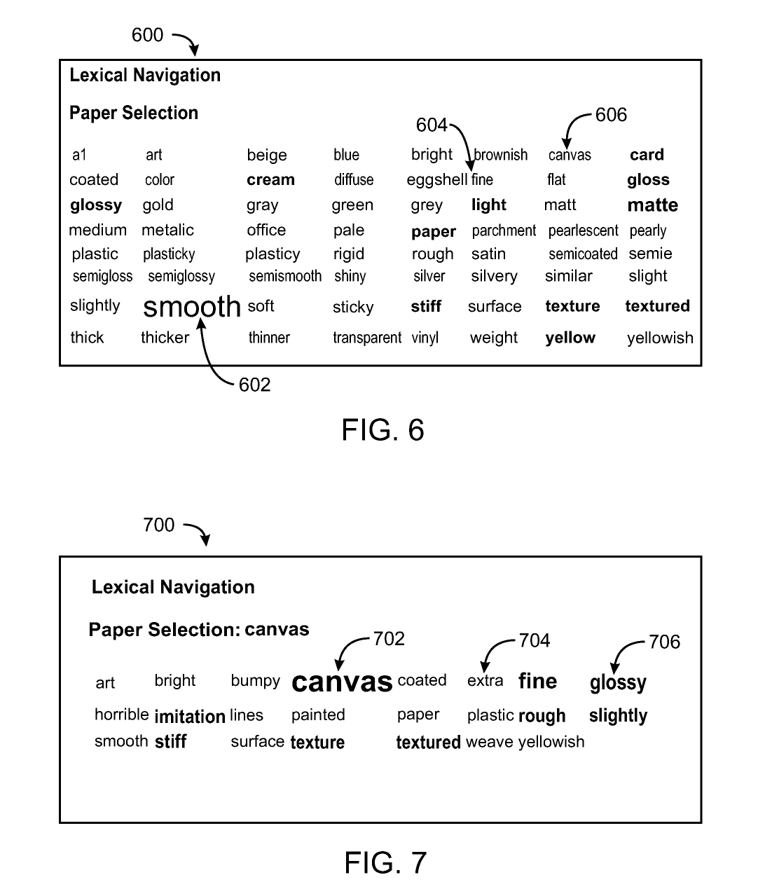

FIG. 6 is a screen shot 600 of a top-level lexical cloud, in accordance with an exemplary embodiment of the present invention. The keywords displayed were scaled based on frequency of use, wherein more frequently used words 602 were larger and less frequently used words 604 were smaller. In this experimental example, lower-level, or nested, lexical clouds were pre-computed for each of the top words. For example, if a user had selected canvas 606, the lower-level lexical cloud shown in FIG. 7 would be displayed. The lower-level lexical clouds are not limited to this example, as lower-level lexical clouds exist for each of the keywords in the screen shot 600. Further, as discussed with respect to FIG. 3, the nested lexical clouds may be generated in real time instead of being pre-computed.

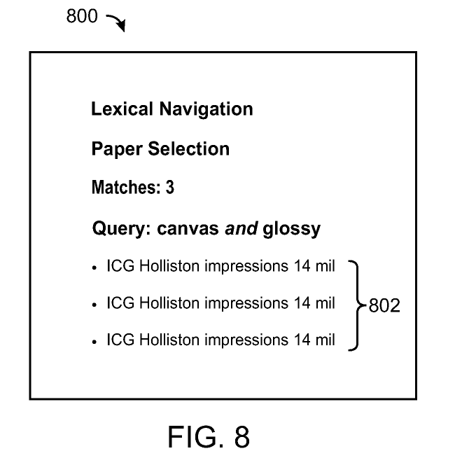

FIG. 7 is a screen shot 700 of a lower-level lexical cloud obtained by the selection of canvas 600 in FIG. 6, in accordance with an exemplary embodiment of the present invention. This is one example of a nested cloud that is associated with a word from the top-level lexical cloud. The nested clouds include the terms frequently used in combination with the keyword in the top-level lexical cloud. As for the top-level lexical cloud, the keywords were sized based on their frequency of use in association with the corpus item, for example, a larger word 702 has a higher frequency of usage, and a smaller word 704 has a lower frequency. In this example, a user may select a keyword in the nested lexical cloud to obtain the corpus items associated with the two keywords, i.e., the keyword selected from the top-level lexical cloud and a keyword selected from the lower-level lexical cloud. For example, if the user selects glossy 706 in the second lexical cloud, a selection of papers meeting these descriptions is provided, as shown in FIG. 8.

FIG. 8 is a screen shot of an item list obtained from searching the data structure of the corpus for items that are associated with both canvas and glossy, in accordance with an exemplary embodiment of the present invention. As shown in FIG. 8, three items 802 have been described with the keywords “canvas” and “glossy.”

The steps have also been performed on technical reports and a sampling of color-related patent applications. In these cases, the data structure was generated from an analysis of the abstract of each document, although any section of the documents may be used. In both cases, the system provided an easily used navigation tool for identifying items that related to particular topics, without having to be aware of the precise terminology used.

The system and methods described herein provide for scalable visualization of a large number of records through nested lexical clouds and an intuitive exploration of records through frequency sorted automatic keywords. The methods and systems are not limited to the selections of papers or substrates, but can be applied across multiple domains, including, for example, the exploration of technical reports and patent abstracts, and the selection of packaging materials, among others. In the case where an experimental corpus is used, such as the media scaling experiment data described above, the systems and methods also yield a system that is based on collective linguistics and is independent of vendors or branded descriptions.

In an exemplary embodiment, the techniques described herein may be used in conjunction with advanced sensor hardware. Specifically, the output of the sensors may be used to connect perceptual or descriptive keywords with measurements obtained from the hardware. For example, a colorimeter may be calibrated to not only output a numerical value for a color, but also to output the descriptive term used most often for that color. The result may be a hardware sensor configuration that can automatically correlate corpus items to user keywords provided for other corpus items, which may reduce or eliminate the need for users to enter descriptive terms for each item. This may simplify the addition of new materials to the data structure.

What is claimed is:

1. A system for lexical navigation of a corpus of items, comprising:
a processor; and
a memory, wherein the memory comprises code configured to direct the processor to:
generate a data structure comprising:
a plurality of items;
a plurality of keywords; and
a frequency that each of the plurality of keywords is associated with each of the plurality of items;
generate a top-level lexical cloud, comprising a subset of the plurality of keywords, wherein each keyword in the top-level lexical cloud has an associates size that is proportional to the keywords frequency of appearance in the data structure; and
generate a lower-level lexical cloud, wherein the lower level lexical cloud is generated from a temporary data structure created by removing any items not associated with a selected keyword from the top-level lexical cloud.

2. The system of claim 1, wherein the memory comprises code configured to direct the processor to display a lexical cloud and obtain a selection of a keyword in the lexical cloud.

3. The system of claim 1, wherein the memory comprises code configured to direct the processor to display a subset of the plurality of items based, at least in part, on keywords selected from two or more nested lexical clouds.

4. The system of claim 1, comprising a storage device that comprises technical documents, patents, Web pages, word processing documents, spreadsheet documents, or any combinations thereof.

5. The system of claim 4, wherein the memory comprises code configured to direct the processor to access files stored the storage device and to generate the plurality of keywords from the files.

6. The system of claim 1, wherein the memory comprises code configured to direct the processor to determine a number of keywords in the top-level lexical cloud based, at least in part, on a size of a display area.

7. The system of claim 1, wherein the memory comprises code configured to determine a number of keywords in the lower-level lexical cloud based, at least in part, on a size of a display area.

8. The system of claim 1, wherein the memory comprises code configured to direct the processor to determine a size of each keyword in a lower-level lexical cloud based, at least in part, on the frequency of the keyword in the temporary data structure.

9. The system of claim 1, wherein the memory comprises code configured to direct the processor to select a subset of the plurality of keywords based, at least in part, on a frequency of occurrence of each keyword in the data structure.

10. The system of claim 1, wherein the memory comprises code configured to direct the processor to generate the top-level lexical cloud, a plurality of lower level lexical clouds, or both in real time.

11. The system of claim 1, wherein the memory comprises code configured to direct the processor to generate a list of items to display based, at least in part, on a size of a display area.

12. The system of claim 1, wherein the memory comprises code configured to direct the processor to generate at least part of the plurality of keywords for the data structure based, at least in part, upon a measurement from a sensor.

13. A method for lexical navigation of a corpus of items, comprising:
generating a data structure in a non-transitory, computer readable medium, comprising:
a plurality of items;
a plurality of keywords; and
a frequency that each of the plurality of keywords is associated with each of the plurality of items; and
generating a top-level lexical cloud, wherein the top-level lexical cloud comprises a subset of the plurality of keywords, and wherein each keyword in the subset is proportional in size to an overall frequency of occurrence of the keyword in the data structure; and
generating a plurality of lower-level lexical clouds, wherein each lower-level lexical cloud is generated by:
eliminating any one of the plurality of items not associated with a particular one of the plurality of keywords from the data structure; and
generating the lower level lexical cloud as a second subset of the plurality of keywords that remain in the data structure, wherein each keyword in the second subset is proportional in size to an overall frequency of occurrence of the keyword in the data structure.

14. The method of claim 13, wherein the second subset is chosen by the overall frequency of occurrence in the data structure after elimination of the any one of the plurality of items not associated with a particular one of the plurality of keywords.

15. The method of claim 13, comprising obtaining the plurality of keywords by:
obtaining a list of words associated with an item;
excluding common words from the list;
stemming words to obtain the plurality of keywords; and
storing each of the plurality of keywords in the data structure.

16. The method of claim 13, comprising displaying a list of items selected from the plurality of items based, at least in part, upon a selection of a first keyword from the top level lexical cloud and a selection of a second keyword from the lower level lexical cloud.

17. The method of claim 13, comprising generating at least part of the plurality of keywords for the data structure based, at least in part, on aesthetic descriptions provided during physical examination of the items.

18. A non-transitory, computer-readable medium, comprising code configured to direct a processor to:
generate a data structure comprising:
a plurality of items;
a plurality of keywords; and
a frequency that each of the plurality of keywords is associated with each of the plurality of items;
generate a top-level lexical cloud, comprising a subset of the plurality of keywords, wherein each keyword in the top-level lexical cloud is sized proportionally to its frequency of appearance in the data structure; and
generate a lower-level lexical cloud, wherein the lower level lexical cloud is generated from a temporary data structure created by removing any items not associated with a selected keyword from the top-level lexical cloud.

19. The non-transitory, computer-readable medium of claim 18, comprising code configured to direct the processor to display a lexical cloud and obtain a selection of a keyword from the lexical cloud.

20. The non-transitory, computer-readable medium of claim 18, comprising code configured to direct the processor to display a subset of the plurality of items based, at least in part, upon a first keyword selected from the top-level lexical cloud and a second keyword selected from the lower-level lexical cloud.
